(19) United States
(12) Patent Application Publication
(10) Pub. No.: US 2003/0132967 A1
(43) Pub. Date: Jul. 17, 2003

(54) System and method for a drag and drop interface for transfer of multiple files between a web enabled device and a web server

(76) Inventor: Ram Gangadharan, The Woodlands, TX (US)

Correspondence Address: RAM GANGADHARAN, 106 W. HOBBIT GLEN DRIVE, THE WOODLANDS, TX, 77384, US

(21) Appl. No.: 10/045,735

(22) Filed: Jan. 15, 2002

(51) Int. Cl. G09G 5/00

(52) U.S. Cl. 345/769

(57) ABSTRACT

This invention describes a System and method for transferring multiple files between a Web Server and a Web Enabled Device, utilizing a drag and drop user interface. To transfer the files from a Web Enabled Device to a Web Server, the user first selects all the files on the Web Enabled Device that need to be transferred. The user then drags the files from the Web Enabled Device on to a specified location of a Website hosted by the above mentioned Web Server. To transfer the files from a Web Server to a Web Enabled Device, the user first selects all the files on the Website that is hosted by the Web Server. The user then drags the files from the Website on to the desired location in the Web Enabled Device.

### CROSS-REFERENCE TO RELATED APPLICATIONS

### U.S. PATENT DOCUMENTS

| | | |
|---|---|---|
| 5,801,700 | Sep. 1, 1998 | Ferguson |
| 5,845,282 | Dec. 1, 1998 | Alley, et al. |
| 5,613,108 | Mar. 18, 1997 | Morikawa |
| 6,073,133 | Jun. 6, 2000 | Chrabaszez |
| 5,416,901 | May 1, 1995 | Torres |

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC APPENDIX

Not Applicable

### BACKGROUND OF THE INVENTION

This invention relates generally to file transfers between a Web Enabled Device and a Web Server. More particularly, the invention relates to a system and method for a drag and drop user interface from a Web Enabled Device to a Website and vice-versa allowing for simplified file transfers between the Web Enabled Device and the Web Server which hosts the Website.

The Web Enabled Device referred to in this invention encompasses any device that allows for Internet connection and includes but is not limited to desktop computers, laptop computers, pen-based computers, hand-held computers, mobile devices and other intelligent devices. The Web Server referred to in this invention refers to a System that hosts a Website. The Web Browser referred to in this invention refers to software that can be used to view Websites. Examples of Web Browsers include Internet Explorer and Netscape.

There has been a tremendous demand for Web based Electronic mail (email) systems like hotmail.com, Web based file storage systems like freedrive.com, Web based photograph-viewing sites like photoloft.com etc. All of these Websites need a method of transferring files (word documents, spreadsheets, pictures, video clips, audio files etc.) from the user's Web Enabled Device to a Web Server. Due to the exploding popularity of these kind of sites, people with varying backgrounds and varying amount of technical prowess are utilizing these sites. To accommodate the users with little or no technical expertise there is a growing need for more efficient, intuitive and user friendly interfaces for file transfers between a Web Enabled Device and a Web Server.

With many current desktop environments, users can manipulate files by clicking and dragging icons across the desktop. For example, to transfer a file from one folder to another, the user simply drags the icon representing the file from one folder to another. This drag and drop user interface provides the user with a user friendly and intuitive interface that is easy to use, even for non-technical users. The drag and drop features of this interface, however, have been traditionally confined within the domain of the desktop.

To transfer files between a Web Enabled Device and a Web Server requires several steps to complete and sometimes even requires the entry of information by the user. In these situations, the intuitive aspect of the interface is lost and a higher degree of user knowledge is required to perform the desired operations. Also, only one file can be selected for transfer at any single time. This makes the process even more tedious and time consuming. One such situation, which requires the user to perform a series of steps, is incorporating attachments in a Web based email system like hotmail.com or yahoo.com.

### BRIEF SUMMARY OF THE INVENTION

The objective of the invention is to simplify the file transfer process between a Web Enabled Device and a Web Server by using the intuitive drag and drop process.

To transfer the files, the user first selects all the files that need to be transferred. To transfer the files to the Web Server from a Web Enabled Device, the user then drags the files from the Web Enabled Device to a specified location of a Website that is hosted by the Web Server. To transfer the files to the Web Enabled Device from a Web Server, the user drags the files from a Website hosted by the Web Server on to the desired folder in the Web Enabled Device. The invention captures information from the files and transfers the files using the already existing Internet connection.

An advantage of the invention is that it eliminates several of the cumbersome steps of selecting the files to be transferred. The invention will allow the user to simply use the drag and drop interface to transfer files between a Web Enabled Device and a Web Server.

A further advantage of the invention is that multiple files that can be transferred at one time.

Yet another advantage of the invention is the intuitiveness of the approach due its graphical drag and drop interface.

A further advantage of the invention is that it will allow for an alternative method of transfer of files from one user to another. A user could transfer files from his Web Enabled Device to a Web Server by dropping the files onto a specified location of a Website hosted by the Web Server. Another user could then transfer those files from the Web Server to his Web Enabled Device by dragging the files from the same Website and dropping them on to his Web Enabled Device.

An additional advantage of the invention is that the file transfers between a Web Enabled Device and a Web Server requires only an Internet connection. Files can therefore be transferred to and from any Web Server that allows for this kind of transfer.

A yet another additional advantage of the invention is that it can provide an indication to the user as to the status of the transfer. This indication can be in the form of a bar graph, a percent-transferred indicator, a time-to-complete indication, and other like indicators.

A further additional advantage of the invention is that files can be moved between the Web Enabled Device and the Web Server in addition to being copied.

Further features and advantages of the present invention, as well as the structure and operation of various embodiments of the present invention, are described in detail below with reference to the accompanying drawings.

### BRIEF DESCRIPTION OF THE SEVERAL VIEWS OF THE DRAWING

The present invention is described with reference to the accompanying drawings. The left-most digit of a reference number identifies the drawing in which the reference number appears.

FIG. 1 is an operational flow diagram illustrating a process for the transfer of files from a Web Enabled Device to a Web Server, according to one embodiment of the invention.

FIG. 2 is an operational flow diagram illustrating a process for the transfer of files from a Web Server to a Web Enabled Device, according to one embodiment of the invention.

FIG. 3A, FIG. 3B and FIG. 3C are diagrams collectively illustrating the current state of art of transferring email attachments from a Web Enabled Device to a Web Server. FIG. 3A is a page of the hotmail.com Website that the user would use to compose an email.

FIG. 3B is a page of the hotmail.com Website that is displayed when a user wants to attach files to the email. FIG. 3C is a file selection dialog box to select a file that needs to be attached to the email.

FIG. 4A, FIG. 4B and FIG. 4C are diagrams collectively illustrating the current state of art of file transfer from a Web Server to a Web Enabled Device. FIG. 4A is a page of the download.com Website to download the McAfee.com VirusScan Online software. FIG. 4B is a File Download box that is displayed to allow the user to save the selected program to disk. FIG. 4C is a file save dialog box to allow the user to save the file to a desired location on his Web Enabled Device.

FIG. 5A, FIG. 5B and FIG. 5C are diagrams collectively illustrating the invention where multiple files can be transferred from a Web Server to a Web Enabled Device according to one embodiment of the invention. FIG. 5A is a diagram illustrating a Website from where multiple files can be transferred to a Web Enabled Device. FIG. 5B is a diagram illustrating the options available to the user when transferring files. FIG. 5C is a diagram illustrating the status dialog box that is displayed when the transfer of files are in progress according to one embodiment of the invention.

FIG. 6 is a diagram illustrating an example of file transfer from one Web Enabled Device to another according to one embodiment of the invention.

### DETAILED DESCRIPTION OF THE INVENTION

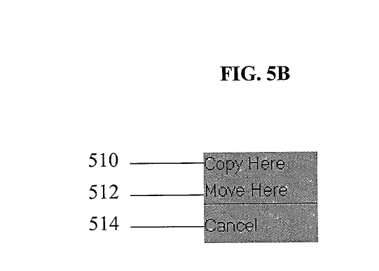

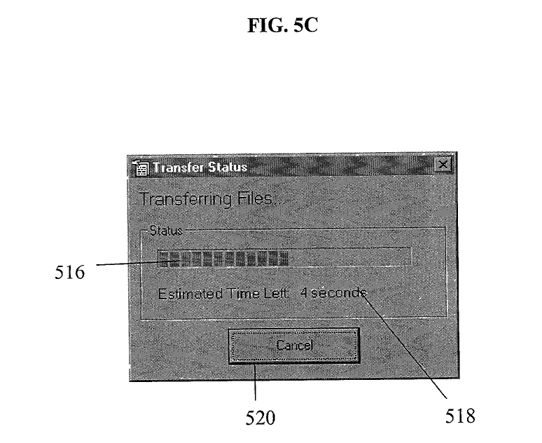

The present invention is directed towards a system and method for transferring files between a Web Enabled Device and a Web Server, utilizing a drag and drop user interface. The invention is described in this document in terms of transferring multiple files between a Web Enabled Device and a Web Server using an existing Internet connection and an appropriate layout of the Website. An example of an appropriate layout is shown in FIG. 5A. After reading this description, it will become apparent to a person skilled in the relevant art how to implement the invention using different layouts of the Website and different connection protocols.

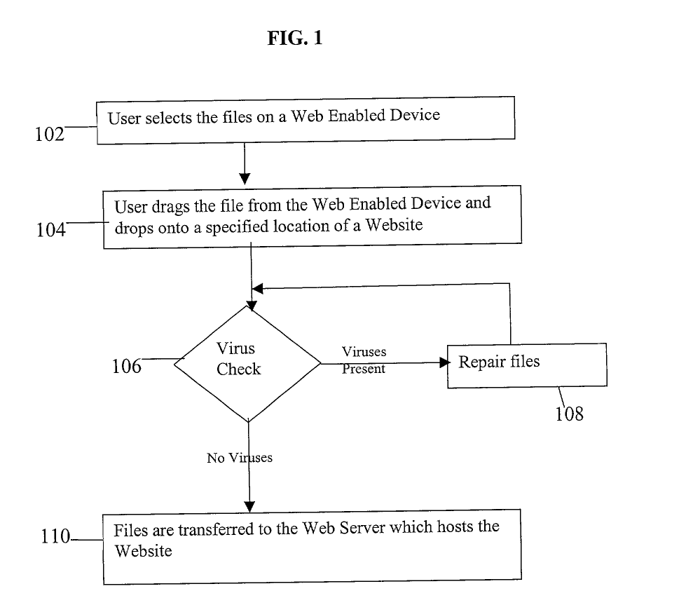

Referring now to FIG. 1, in step 102 the user first selects the files on the Web Enabled Device that he wants transferred to a Web Server. The user will usually select the files with a pointing device like a mouse. The files are selected from folders on the user's Web Enabled Device. Entire folders could also be selected. In step 104, the user then drags the files from the Web Enabled Device and drops them onto a specified location of a Website hosted by the above mentioned Web Server. In Step 106, the files are checked for viruses using any commercial anti-virus software package. In Step 108, the viruses are repaired in case of virus infection of the files. Steps 106 and 108 are repeated until there are no viruses in the files. In Step 110, the files are transferred to the Web Server that hosts the Website.

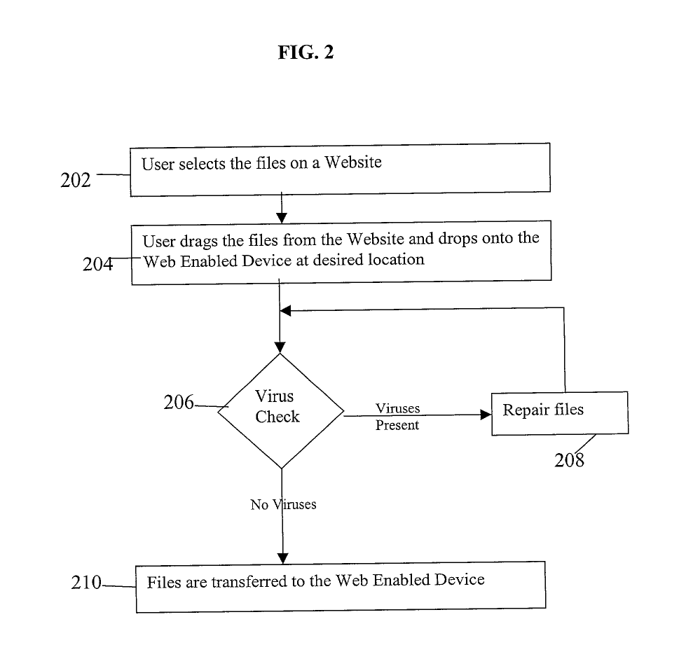

Referring now to FIG. 2, in step 202 the user first selects the files on the Website that he wants transferred to a Web Enabled Device. The selection mechanism will depend on the layout of the Website. In one embodiment, the user will select the file by simply clicking on the file. In another embodiment, the user will select multiple files on the Website by highlighting all the files that need to be transferred. This invention will provide a method to allow for multiple selection of files in a Web Browser. Selecting multiple files for transfer in a Web Browser cannot be accomplished with the current state of art. In step 204, the user drags the selected files from the Website to the desired location on the Web Enabled Device. In step 206, the files are checked for viruses using any commercial anti-virus software package. In step 208, the viruses are repaired in case of virus infection of the files. Steps 206 and 208 are repeated until there are no viruses in the files. In Step 210, the files are transferred to the Web Enabled Device.

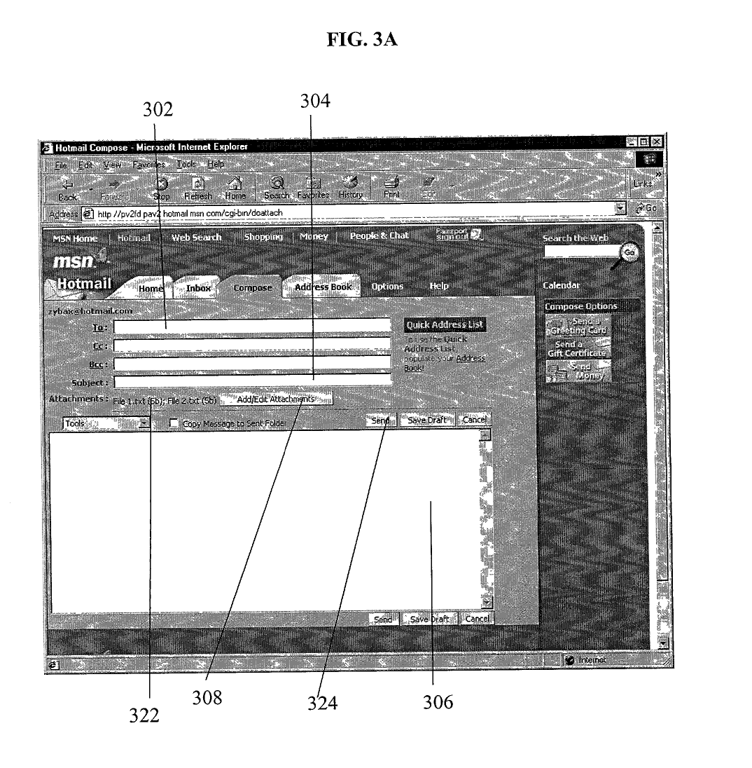

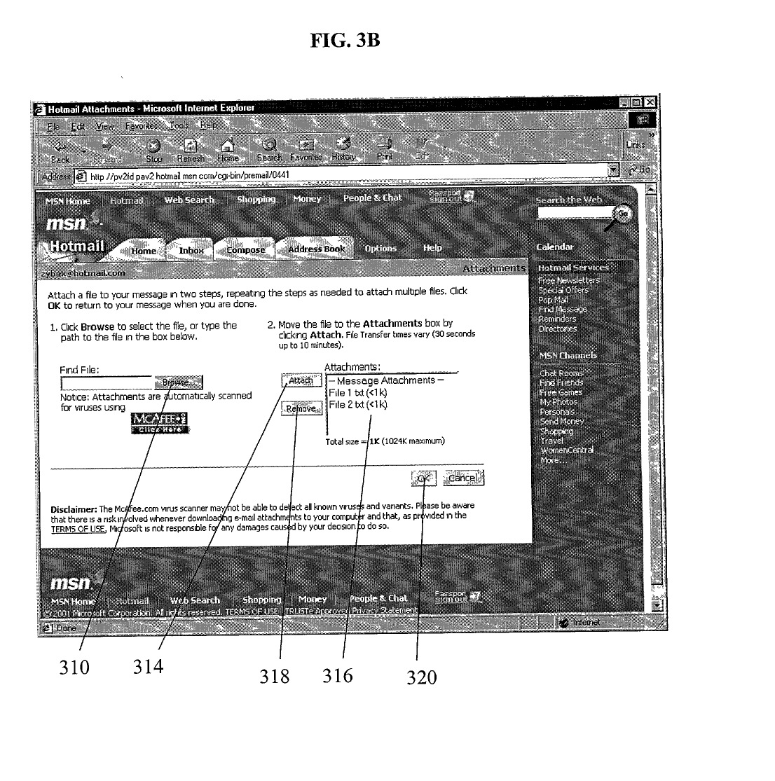

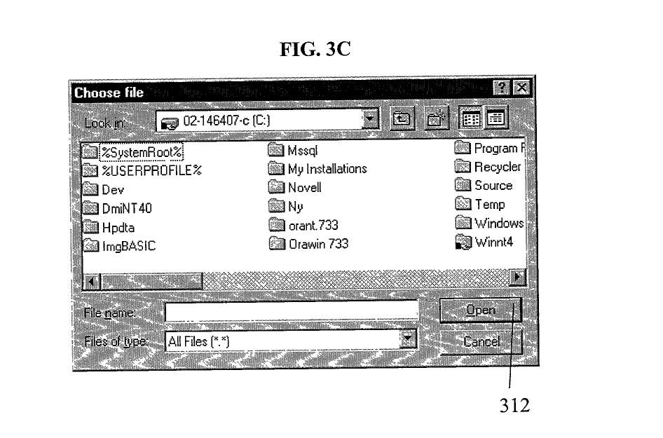

Before describing the invention in further detail, it will be useful to describe the current state of art that is used to transfer files from a Web Enabled Device to a Web Server. The current state of art will be described using FIG. 3A, FIG. 3B and FIG. 3C. FIG. 3A illustrates a page of hotmail.com, where you can compose and send an email. To send an attachment through this email system, one would need to transfer a file from the Web Enabled Device to the Web Server. The attachment could be any file that is on the Web Enabled Device. In order to attach a file to an email, the user would perform the following steps:

1. User fills out the recipient's email address, subject of the email and text of the email in the 302,304 and 306 area respectively of FIG. 3A.

2. In order to send the attachment, the Add/Edit Attachments button 308 of FIG. 3A is clicked.

3. When the Add/Edit Attachments button is clicked, the diagram shown in FIG. 3B is displayed on the Web Browser.

4. To attach a specific file, The Browse button 310 of FIG. 3B is clicked. The file selection dialog box shown in FIG. 3C will be displayed.

5. The user then navigates the file system to select the file that needs to be attached to the email. This is typically the most difficult task for users with little technical expertise, since users are not necessarily comfortable with navigating through a directory structure. After the file is selected, the Open button 312 of FIG. 3C is clicked.

6. The user is then brought back to the diagram shown in FIG. 3B. The user then clicks on the Attach Button 314 of FIG. 3B.

7. The current state of art allows only file to be selected at a time, and therefore steps 4-6 are repeated to attach additional files.

8. Files that are attached to the email are displayed in area 316 of FIG. 3B. To remove any particular file, the file can be selected in area 316 of FIG. 3B and the Remove button 318 of FIG. 3B is clicked.

9. The user then clicks on the OK button 320 of FIG. 3B. This brings the user back to the diagram shown in FIG. 3A. The attachments are listed in area 322 of FIG. 3A.

10. The user then clicks on the Send Button 324 of FIG. 3A to send the email along with the attachments.

As can be seen from the above steps, it is obvious that several steps are needed to send an email with an attachment. The objective of one of the embodiments of the invention is to simplify the above steps and make it more intuitive. The steps the user will follow with the invention in one of the embodiments is:

1. User fills out the recipient's email address, subject of the email and text of the email in the 302,304 and 306 area respectively of FIG. 3A.

2. The user then drags all the files that need to be transferred from the Web Enabled Device onto the Web Browser. The files could be dragged onto area 306 of FIG. 3A or any other designated area specified by the designer of the Website. The attachments will be listed in area 322 of FIG. 3A.

3. The user then clicks on the Send Button 324 of FIG. 3A to send the email along with the attachments.

As can be seen from above, the number of steps to incorporate a file attachment to a Web based email is drastically reduced. It is also more intuitive and easier to accomplish than the current state of art. A further advantage of the invention in this embodiment is that multiple files can be transferred as an attachment at a single time. At the current time, several Websites like hotmail.com, yahoo.com, freedrive.com, photoloft.com among several thousand others utilize the conventional method of transferring files from the user's Web Enabled Device to their Web Server and would find this invention very helpful for their users.

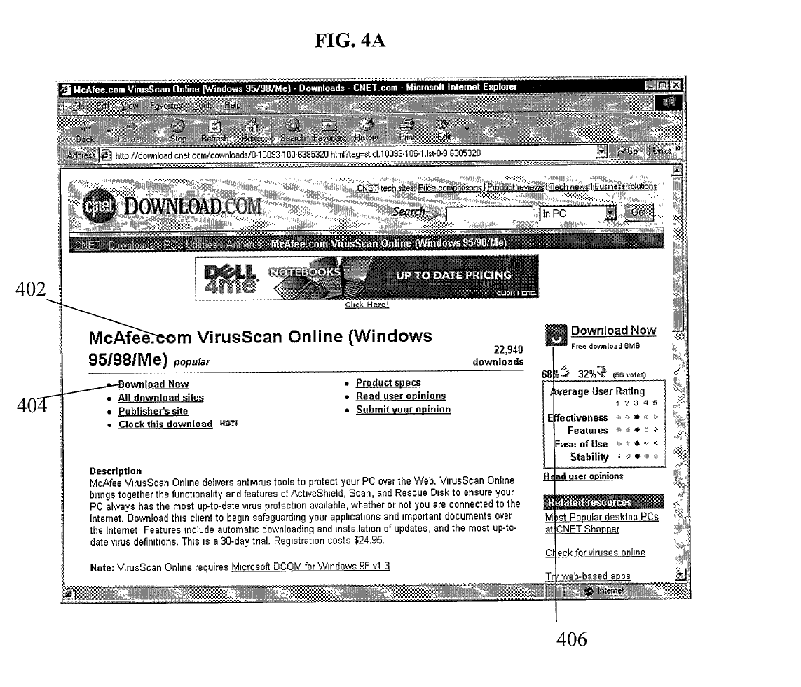

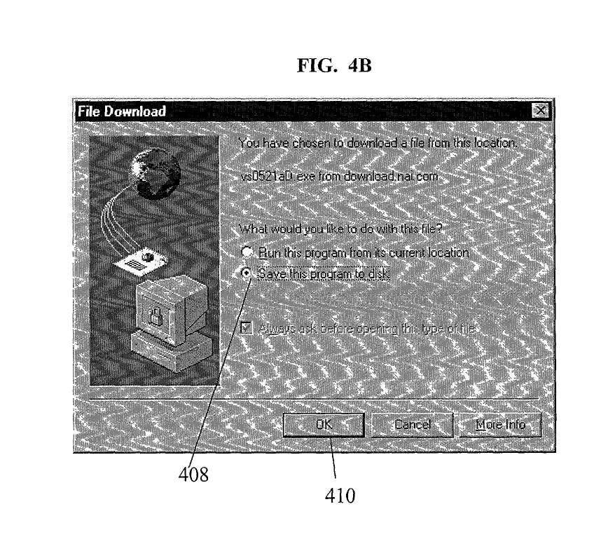

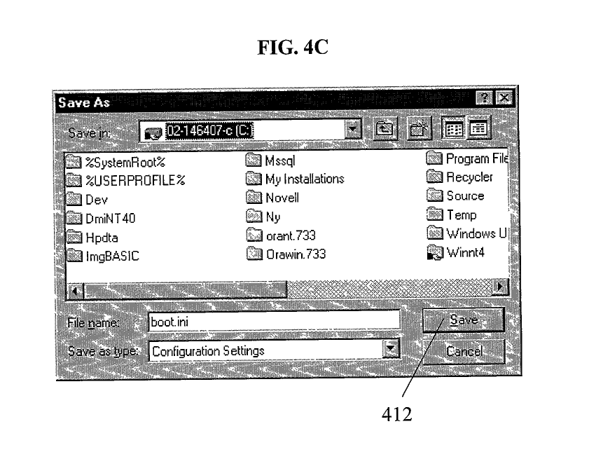

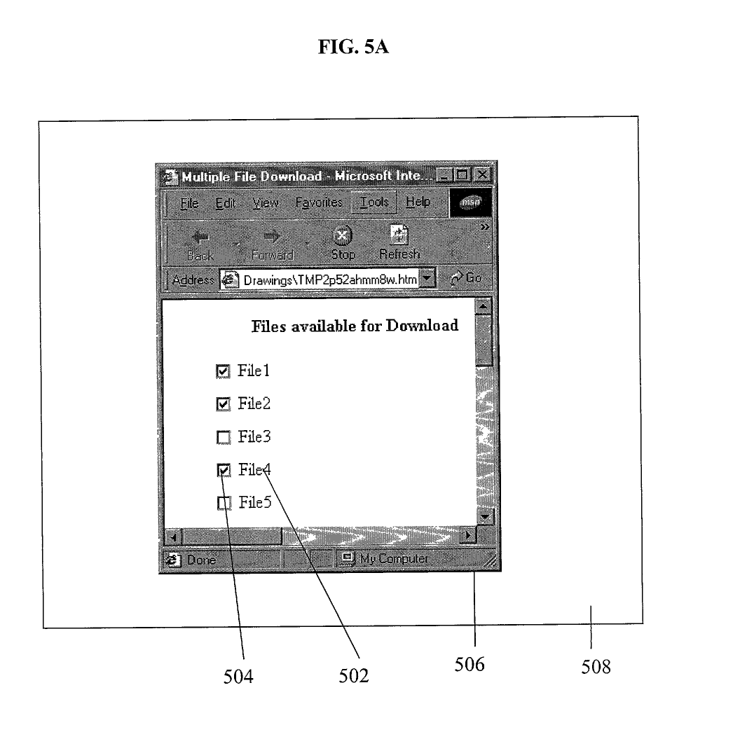

Another embodiment of the invention is the ability to transfer files from a Web Server to a Web Enabled Device. This is achieved by dragging the files from a Website hosted by the Web Server to the Web Enabled Device. Before describing the invention in further detail, it would be useful to describe the current state of the art to transfer files from a Web Server to a Web Enabled Device. The current state of art will be described using FIG. 4A, FIG. 4B and FIG. 4C. FIG. 4A shows a page of the Website download.com where a user would want to download the McAffee.com VirusScan Online software 402 of FIG. 4A. This is just an example and would apply for any software that the user would want to download from this site or any other site. Following are the steps the user would perform to achieve his goal of downloading the software to his Web Enabled Device:

1. User will click on the Download Now hyperlink 404 of FIG. 4A. The file download dialog box shown in FIG. 4B will be displayed.

2. The user will then ensure that the option “Save this program to disk” 408 of FIG. 4B is selected.

3. The user will then click the OK button 410 of FIG. 4B. The file save dialog box shown in FIG. 4C will be displayed.

4. The user then navigates through the file system until the desired location is reached. This is typically the most difficult task for users with little technical expertise, since users are not necessarily comfortable with navigating through a directory structure. The user will then click on the Save Button 412 of FIG. 4C. This will save the file to the desired location on the Web Enabled Device.

As can be seen from above, several steps are needed to complete the processes of transferring a file to the user's Web Enabled Device from a Web Server. The objective of one of the embodiments of the invention is to simplify the above steps and make it more intuitive. The steps the user will follow with the invention in one of the embodiments is:

1. The user simply drags the icon 406 of FIG. 4A that represents the McAfee.com VirusScan Online software to the desired location on the user's Web Enabled Device.

As can be seen from above, the number of steps to transfer a file from a Web Server to a Web Enabled Device is drastically reduced. It is also more intuitive and easier to accomplish than the current state of art. A further advantage of the invention in this embodiment is that multiple files can be transferred at a single time.

FIG. 5A, FIG. 5B and FIG. 5C are diagrams collectively illustrating the invention where multiple files can be transferred from a Web Server to a Web Enabled Device according to one embodiment of the invention. Referring now to FIG. 5A, Files 502 can be selected by clicking on the checkbox 504. In this example, File1, File2 and File4 have been selected. The Files are then dragged from the Web Browser 506 and dropped on to the desired folder in The Web Enabled Device 508 by using a pointing device like a mouse. In one embodiment of the invention, the user clicks on any of the selected files 502 and this will allow all the selected files to be dragged from the Website to the Web Enabled Device. When the files are dropped onto the desired folder in the Web Enabled Device, the screen displayed in FIG. 5B is displayed. This gives the user the option of moving the files 510 of FIG. 5B, copying the files 512 of FIG. 5B or canceling the operation 514 of FIG. 5B. When the user selects the copy or move option, the transfer status window shown in FIG. 5C is displayed. The progress of the file transfer process is shown in progress bar 516 of FIG. 5C. The estimated time left for completion of the transfer process is shown in Label 518 of FIG. 5C. The transfer process can be canceled by clicking on the Cancel Button 520 of FIG. 5C.

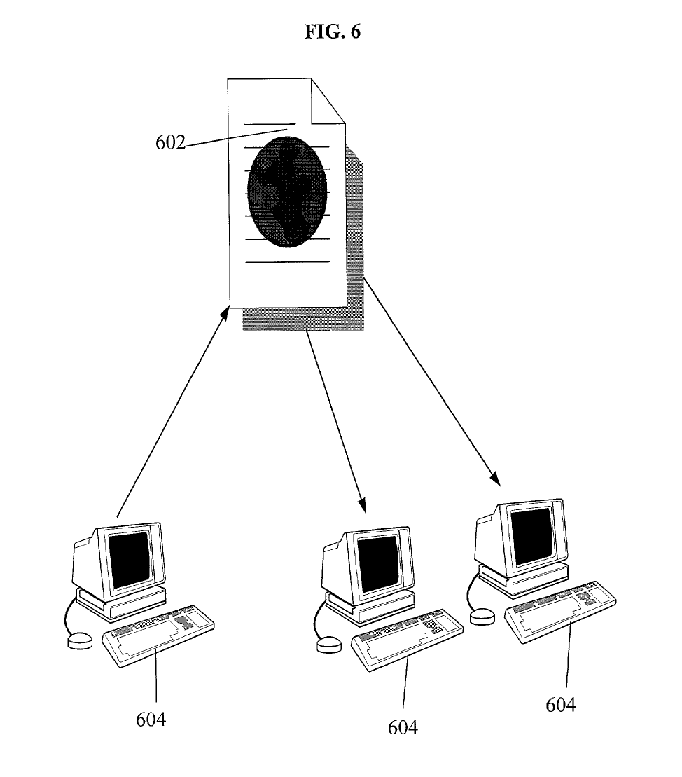

Yet another application for this invention is illustrated in FIG. 6. In this embodiment of the invention, files are transferred from one user to another via a Web Server. A user on a Web Enabled Device 604 of FIG. 6 transfers files from his Web Enabled Device to a Web Server by dragging and dropping files from his Web Enabled Device to a particular Web Site 602 of FIG. 6. Users on other Web Enabled Devices 604 of FIG. 6 (only two recipient Web Enabled Devices are shown here, but there could be an unlimited number of Web Enabled Devices) then drag the files from the Web Site 602 of FIG. 6 onto their respective Web Enabled Devices 604. It is not intended that the invention be limited to applications in this example environment. In fact, after reading the description in the invention, it will become apparent to a person skilled in the relevant art how to implement the invention in alternative environments.

This invention will be carried out by writing a program, which will be installed as a plugin to the Web Browser on the Web Enabled Device. All Web Browsers including Internet Explorer and Netscape will be supported. All Web Enabled Devices that have the plugin installed will be able to transfer multiple files between a Web Enabled Device and a Web Server by using the drag and drop user interface. The invention will also include the ability to move the files in addition to copying the files, canceling the transfer process and viewing the status of the file transfer process.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

I claim:

1. A System for implementing an electronic file transfer from a Web Enabled Device to a Web Server in response to an iconic drag and drop interface, where a user drags the files from the said Web Enabled Device to a specific location on the Website hosted by the said Web Server, the system comprising:
Means for capturing information about the selected files when the user drags them from the said Web Enabled Device and drops them onto a specific location of the said Website;
Means for transferring the files from the said Web Enabled Device to the said Web Server using an existing Internet connection.

2. A System for implementing an electronic file transfer from a Web Server to a Web Enabled Device in response to an iconic drag and drop interface, where a user drags the files from a Website hosted by the said Web Server to the said Web Enabled Device. The system comprising:
Means for selecting multiple files in a Web Browser;
Means for capturing information about the selected files when the user drags them from the said Website and drops them onto the desired folder of the said Web Enabled Device;
Means for transferring the files from the said Web Server to the said Web Enabled Device using an existing Internet connection.

3. A computer program product for use with a Web Enabled Device, said computer program product comprising:
A computer usable medium having computer readable program code embodied in said medium to transfer files electronically from the said Web Enabled Device to a Web Server in response to an iconic drag and drop user interface, said computer readable program code comprising:
Computer readable program code for capturing information about the selected files when the user drags them from the said Web Enabled Device and drops them onto a specific location of a Website hosted by the said Web Server;
Computer readable program code for transferring the files from the said Web Enabled Device to the said Web Server using an existing Internet connection.

4. A computer program product for use with a Web Enabled Device, said computer program product comprising:
A computer usable medium having computer readable program code embodied in said medium to transfer files electronically from a Web Server to the said Web Enabled Device in response to an iconic drag and drop user interface, said computer readable program code comprising:
Computer readable program code for selecting multiple files in a Web Browser;
Computer readable program code for capturing information about the selected files when the user drags them from the a Website hosted by the said Web Server and drops them onto the desired folder of the said Web Enabled Device;
Computer readable program code for transferring the files from the said Web Server to the said Web Enabled Device using an existing Internet connection.

5. A computer program medium readable by a Web Enabled Device, tangibly embodying a program of instructions executable by the said Web Enabled Device to perform steps for transferring files from the said Web Enabled Device to a Web Server in response to an iconic drag and drop user interface, said steps comprising the steps of:
Capturing information about the selected files when the user drags them from the said Web Enabled Device and drops them onto a specific location of a Website hosted by the said Web Server;
Transferring the files from the said Web Enabled Device to the said Web Server using an existing Internet connection.

6. A computer program medium readable by a Web Enabled Device, tangibly embodying a program of instructions executable by the said Web Enabled Device to perform steps for transferring files from a Web Server to the said Web Enabled Device in response to an iconic drag and drop user interface, said steps comprising the steps of:
Selecting multiple files in a Web Browser;
Capturing information about the selected files when the user drags them from the a Website hosted by the said Web Server and drops them onto the desired folder of the said Web Enabled Device;
Transferring the files from the said Web Server to the said Web Enabled Device using an existing Internet connection.
